(19) United States
(12) Patent Application Publication
(10) Pub. No.: US 2004/0103973 A1
(43) Pub. Date: Jun. 3, 2004

(54) Planar element and method for producing a planar element

(76) Inventors: Hartmut Carstensen, Berlin (DE); Peter Buchwald, Bergfelde (DE); Ian Meyer Neelachmann, Schildow (DE)

Correspondence Address: HOWREY SIMON ARNOLD & WHITE, CITYPOINT, ONE ROPEMAKER STREET, LONDON, EC2Y 9HS, GB

(21) Appl. No.: 10/204,488

(22) PCT Filed: Feb. 17, 2001
(86) PCT No.: PCT/EP01/01781

(30) Foreign Application Priority Data
Feb. 21, 2000 (DE) 100 09 106.7

(51) Int. Cl. B32B 7/04

(52) U.S. Cl. 156/91

(57) ABSTRACT

In the present method for producing a planar element (2) for car bodies in differential construction, which includes an external skin (4) and at least one stiffening means implemented as planar, profiles (8) and profile nodes (10) being provided in a predetermined arrangement on the external skin (4), in a first step the stiffening means is glued to the external skin (4), in a second step profiles (8) and profile nodes (10) are arranged and joined into a frame, at least partially using a cold joining method, and in a third step the frame is joined to the external skin (4) on the side of the stiffening means, at least partially using a cold joining method. High planar buckling resistance of the plate panels is achieved through these measures.

The present invention relates to a method for producing a planar element, for car bodies in differential construction, which includes an external skin and stiffening means, profiles and profile nodes being provided in a predetermined arrangement on the external skin, and to a planar element.

Car bodies, for example for passenger traffic, are constructed from various components. These components include, among other things, planar elements. The planar elements are in turn assembled from multiple plates and semifinished products, which are joined to one another. Various welding techniques, such as spot welding and conventional electrical arc welding, are used as joining techniques in this case.

In railway vehicle construction it has been typical and very generally known until now to implement components for car bodies of railway vehicles in differential construction, a framework or latticework joined out of profiles being provided with external skin, which is connected to the framework in such a way that planar elements which are resistant to shearing result. In the areas lying between the lattice rods, the skin is additionally reinforced on the inside by linear, frequently Z-shaped profiles as buckling stiffeners, in order to achieve the necessary buckling resistance of the external skin.

Implementing a latticework for large car bodies from cap-shaped profiles, which are overlapped at their crossing points by profile nodes, also implemented as cap-shaped, and are joined to them by form fitting and material bonding, is known from Great Britain Patent 885,279.

In the cases described above, thermal joining methods are used completely or at least in some sections for the production of the framework or latticework, for the joining to the external skin, and for the subsequent application of the linear buckling stiffeners. It is disadvantageous for all of these joining methods that high precision must be ensured and therefore corresponding expense must he made during the forming of the framework or latticework, and the heat introduced leads to undesired tensions and distortion in all components, which requires time-consuming and costly reworking in order to produce the desired shape and surface evenness of the planar element and remain within the required tolerances.

In addition, a significant thermal distortion arises, which becomes noticeable in the occurrence of buckling and negatively influences the surface quality. To compensate the distortion, extensive alignment and clamping work as well as reworking through renewed grinding are necessary. The dimensional tolerances arising lead to elevated adjustment expense in the final assembly. The known joining methods require extensive subsequent corrosion protection or the use of costly stainless steels. To produce a suitable planar buckling resistance, it is necessary to thermally tension the planar elements in a subsequent treatment or provide them with profile buckling stiffeners.

In addition, these joining methods restrict or prevent the use of materials which already contain inorganic and/or organic corrosion protection films, the production of largely premanufactured components, which, for example, already have a thermal insulation or a final coloration, and the production of hybrid components joined from different materials (including fiber composite materials).

Therefore, replacing thermal joining methods by cold joining methods is increasingly being attempted in the manufacture of railway vehicles.

Joining a latticework and linear buckling stiffeners to an external skin using a gluing method is described in German Patent Application 195 01 805 A1. This technology is not usable and cost effective for all applications.

Planar element modules which are at least partially producible and joinable to one another using cold joining (e.g. punch rivets) in differential construction are known from European Patent Application 0 855 978 A1. This technology sometimes requires high outlay for devices and tools, and its construction is relatively restricted and complicated.

Hollow chamber profiles are costly to design and produce, with extensive and inflexible cast nodes arising and no tolerance compensation being provided. The edge designs of the planar elements in the region profile/plate have also been shown to be very complicated.

WO 97/14596 A1 describes modular elements in differential construction and their production methods. The modular elements include an external skin, a frame profile, which supports the skin and provides contour, having a support surface oriented toward the inside of the external skin, and edge profiles, which connect the ends of the frame profiles to one another and may be laid in pairs on one another along a partition line to connect two bordering modular elements, having recesses for sticking through connection means, which are cold joinable for connecting the modular elements. The recesses in the edge profiles are each arranged in the region of a frame end. The frame ends are each rigidly connected to the frame feet. The frame feet are used to produce direct form-fitting and materially-bonded connections between corresponding frame feet of modular elements bordering one another using the cold-joinable connection means and are in turn rigidly connected by cold-joined connections to the edge profiles in the region of the respective recess. To produce a modular element of this type, a number of frame profiles which provide a contour are cut to a predetermined length. For each lengthwise edge of the modular element, an edge profile is cut to length and provided with recesses at the connection points to the frame profiles. The edge profiles are cold-attached to the frames, which are arrayed in parallel having their ends aligned, using frame feet attached to their ends, the feet also being used to connect the modular elements to one another. An external skin aligned parallel to the sides is laid on the support surface of the frames facing toward the external skin and is permanently cold-connected to this support surface and to the edge profiles.

European Patent Application 0 369 134 A1 discloses a vehicle cell, particularly for a railway vehicle, including a carrier frame and sandwich parts attached thereto, which each contain an external cover layer and an internal cover layer and a support layer glued between them. The vehicle cell is constructed from individually manufactured cell modules, which are each implemented in integral construction as a sandwich structure having carrier frame parts introduced in the region of the support layer and attached to the cover layers and which are provided on the edges of the carrier frame parts with fitted connections for joining the cell modules together.

The use of a hump plate is described, among other things, in P. Cordes, V. Hüller: Moderne Stahl-Leichtbaustrukturen für den Schienenfahrzeugbau; Blech Rohre Profile [Modern Steel Lightweight Structures for Railway Vehicle Construction; Plate Tube Profile] 42 (1995) 12 pp. 773-777. In this hump plate, a smooth plate is connected to a second plate, into which a defined raster of truncated cones or pyramids was shaped. The smooth plate and the hump plate are connected to one another via a spot weld in each of the hump bottoms.

German Patent Application 197 42 772 A1 includes an intermediate floor for a two-story railway car to separate the upper story from the lower. The intermediate floor extends from one lengthwise side of the car to the other and over a section of the length of the car. It includes multiple flat, rectangular sandwich elements lying next to one another, whose narrow faces extend from one lengthwise side of the car to the other and there lie on a girder running in the lengthwise direction of the car, while their wide lengthwise sides are each connected to a hollow and pliable bar, which extends transversely over at least a section of the inner breadth of the car. In one embodiment, the sandwich elements include two plates which have a cell structure, in that depressions are shaped into each of the plates by deep drawing. The tips of the depressions are in contact and are welded to one another.

The present invention is therefore based on the object of indicating a method for producing a planar element for car bodies in differential construction which avoids the disadvantages of known methods, planar elements having low tolerance margins and high surface quality being manufactured. In addition, a planar element produced according to the method according to the present invention is to be indicated.

This object is achieved by a method for producing a planar element for car bodies in differential construction having the features of Claim 1.

In addition, this object is achieved by a planar element produced in this way.

A high planar buckling resistance of the plate panels is achieved using the method for producing a planar element. Only low tolerance margins arise, the leveling of the plate occurring automatically through the glueing process. Through application of tie method, multifaceted functional integration is achieved, corrosion protection and sound insulation being emphasized. Very low component tolerances are achieved through the use of cold joining methods. In addition, significant financial savings are achieved by dispensing with wage-intensive processes, such as aligning, sandblasting, clamping, grinding, and filling. Furthermore, material costs are saved. Base coats may be dispensed with, only undercoats, covering varnish, or foil being necessary. In addition, both hybrid construction and modular construction are made possible using the present method. Planar elements having various profiles may be produced, for example flat or curved side walls.

Preferably, cold joining is used exclusively in the second and third steps. By dispensing with the use of welding methods, the advantages already indicated are further optimized.

The cold joining may particularly be performed using lock ring bolts, punch rivets, or clinching. A combination of lock ring bolts, punch rivets, and clinching is also conceivable. These joining techniques ensure joins having low tolerances, since a shrinking process, which is difficult to calculate and is unavoidable with welding, is avoidable with cold joining.

In a further embodiment of the present invention, the profiles and profile nodes are at least partially arranged and joined in a device. The components of the frame may be brought into the predetermined arrangement with the aid of a mold or template. Latitude for imprecision is thus nearly excluded. In combination with the cold joining techniques, the production of a frame having the highest precision is ensured.

The stiffening means is preferably glued to the external skin in a vacuum bag method. For example, the plates to be glued are introduced into an airtight package, particularly into a film, in which a partial vacuum is subsequently generated, so that the stiffening means presses against the skin and the skin presses against a surface and/or mold, for example for a curved side wall. Using this so-called vacuum bag method, flat surfaces may be produced with the highest precision in a cost-effective way. The method has been shown to be independent of the size of the planar element. Costly individual devices for producing flat planar elements which are dependent on the size of the planar elements are no longer necessary.

Advantageous refinements result from the sub-claims.

The present invention will be described in more detail on the basis of an exemplary embodiment in connection with the attached drawing.

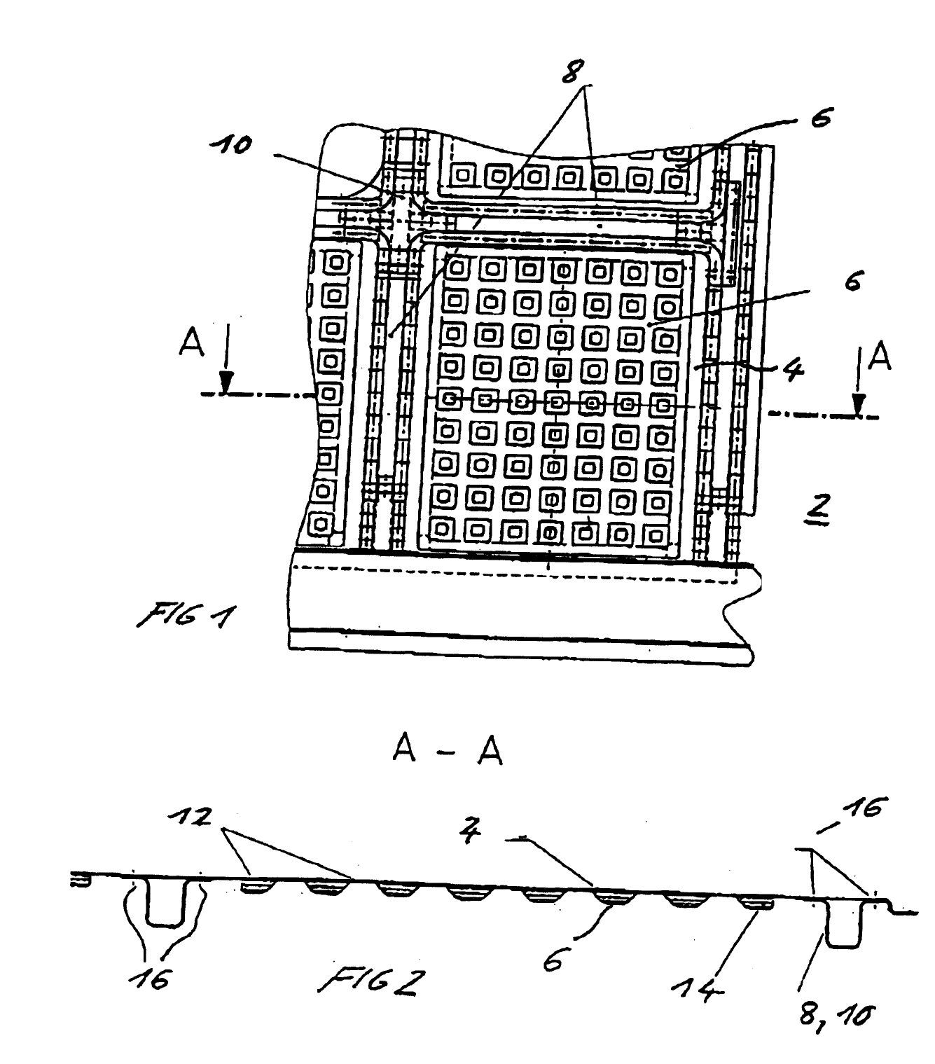

FIG. 1 shows a detail of a planar element for car bodies in differential construction in a top view in a schematic illustration;

FIG. 2 shows a section from FIG. 1 along line A-A.

FIG. 1 shows a detail of a planar element 2 in a top view in schematic illustration. Planar clement 2 includes external skin 4 and hump plates 6, which are arranged on external skin 4. Profiles 8, which are connected to one another via profile nodes 10, are arranged on external skin 4 on the hump plate side. In exemplary embodiments which are not shown, a profiled plate, a combination of foam and cover plate, or a fiber composite semifinished product may, for example, be provided instead of hump plates 6 as stiffening means.

In the present method for producing planar element 2, in a first step hump plates 6 are glued to external skin 4, and these elements are then rigidly connected to one another. In a second step, profiles 8 and profile nodes 10 are arranged in a predetermined way and joined into a frame, at least partially using a cold joining method. In a third step, the frame is joined to external skin 4 on the hump plate side, at least partially using a cold joining method. Alternatively, cold joining may also be used exclusively in the second and third step. In this exemplary embodiment, cap profiles are used as profiles 8 for the frame formation. However, other profiles may also conceivably be used.

Profiles 8 and profile nodes 10 are at least partially arranged and pre-joined in a device. Profiles 8 and profile nodes 10 of the frame are already brought into the final arrangement with the aid of a mold or template. Latitude for imprecision is thus nearly excluded. In combination with the cold joining techniques, the production of a frame having the highest precision is ensured.

The humps of hump plate 6 may be implemented in a plane, regular arrangement in intersecting horizontal and vertical rows or in intersecting diagonal rows.

In a further exemplary embodiment (not shown), the humps of hump plate 6 are implemented in a plane, irregular arrangement, a larger number of humps being arranged at smaller intervals in regions which must have a higher buckling resistance, and a lower number of humps correspondingly being provided in regions having lower requirements for buckling resistance.

Profile nodes 10, which overlap abutting or intersecting profiles 8, which are connected to profiles 8, and which stiffen the butts or intersections of profiles 8, are arranged at the butts or intersections of profiles 8. Some of profiles 8 and the ends of profile nodes 10 facing them have a cap-shaped cross-section. Profile nodes 10 are produced using deep drawing technology.

FIG. 2 shows a section from FIG. 1 along line A-A. External skin 4 is joined to hump plates 6 using an adhesive 12. In addition, an insulating material 14 is located in the spaces implemented between external skin 4 and hump plate 6. The joining is preferably performed in a vacuum bag method. In this exemplary embodiment, the arrangement to be glued is introduced into an airtight package, for example into a film, in which a partial vacuum is subsequently generated. The hump plate may, however, be pressed onto the external skin in another way.

The frame, namely the structure made of profiles 8 and profile nodes 10, is cold joined in the present exemplary embodiment with the aid of punch rivets 16. In a further exemplary embodiment (not shown), the cold joining is performed with the aid of lock ring bolts or clinching. A combination of the cold joining techniques is also suitable.

Using the present method for producing a planar element 2, high planar buckling resistance of external skin 4 and therefore of entire planar element 2 is achieved. Only slight tolerance margins arise, the leveling of the external plate occurring automatically through the gluing process.

1. A method for producing a planar element (2) for car bodies in differential construction, which includes an external skin (4) and a stiffening means, profiles (8) and profile nodes (10) being provided in a predetermined arrangement on the external skin (4),
characterized in that
in a first step, a stiffening means implemented as planar is used and is glued to the external skin (4),
in a second step, profiles (8) and profile nodes (10) are arranged and joined into a frame, at least partially using a cold joining method, and
in a third step, the frame is joined to the external skin (4) on the side of the stiffening means, at least partially using a cold joining method.

2. The method according to claim 1
characterized in that the second and third steps are entirely performed using cold joining.

3. The method according to one of claims 1 or 2,
characterized by cold joining using punch rivets (16).

4. The method according to one of claims 1 to 3,
characterized by cold joining using lock ring bolts or clinching.

5. The method according to one of claims 1 to 4,
characterized in that the profiles (8) and the profile nodes (10) are arranged and joined at least partially in a device.

6. The method according to one of claims 1 to 5,
characterized in that the stiffening means is glued to the external skin (4) in a vacuum bag method.

7. A planar element (2), which is produced according to a method of claims 1 to 6.

8. The planar element according to claim 7,
characterized in that hump plates (6) are rigidly connected to the external skin (4) as stiffening means.

9. The planar element (2) according to claim 8,
characterized in that the humps of the hump plate (6) are implemented in a plane, regular arrangement in intersecting rows running horizontally and vertically.

10. The planar element (2) according to claim 8,
characterized in that the humps of the hump plate (6) are implemented in a plane, regular arrangement in intersecting rows running diagonally.

11. The planar element (2) according to claim 8,
characterized in that the humps of the hump plate (6) are implemented in a plane, irregular arrangement, a larger number of humps being arranged at smaller intervals in regions which must have a higher buckling resistance, and vice versa.

12. The planar element (2) according to one of claims 7 to 11,
characterized in that profile nodes (10), which overlap the abutting or intersecting profiles (8), which are connected to the profiles (8), and which stiffen the butts or intersections of the profiles (8), are arranged at the butts or intersections of the profiles (8).

13. The planar element (2) according to claim 12,
characterized in that at least a part of the profiles (8) and the ends of the profile nodes (10) facing them have cap-shaped cross-sections.

14. The planar element (2) according to claim 13,
characterized in that the profile nodes (10) are produced using deep-drawing technology.

15. The planar element (2) according to claim 13 or 14,
characterized in that the profiles (8) and the profile nodes (10) are connected to one another at least partially through a cold joining method.

16. The planar element according to claim 7,
characterized in that a profiled cover plate, foam and cover plate, or a fiber composite semifinished product is provided as a stiffening means.
